(19) United States
(12) Patent Application Publication
(10) Pub. No.: US 2026/0302940 A1
(43) Pub. Date: Oct. 1, 2026

(54) LOSS APPROXIMATION TECHNIQUES FOR ELECTRIFIED VEHICLE DC-DC BOOST CONVERTERS THROUGH QUADRATIC FITTING

(71) Applicant: FCA US LLC, Auburn Hills, MI (US)

(72) Inventors: Nadirsh D. Patel, Auburn Hills, MI (US); McKenzie T. Walsh, Auburn Hills, MI (US); Achyut Venkataramu, Auburn Hills, MI (US); Shichao Huo, Auburn Hills, MI (US); Gokul Maharaj Badrinath, Auburn Hills, MI (US)

(21) Appl. No.: 19/095,387

(22) Filed: Mar. 31, 2025

(51) Int. Cl. H02M 3/155; B60K 1/02; B60L 15/00; B60L 15/20

(52) U.S. Cl. CPC H02M 3/155; B60K 1/02; B60L 15/007; B60L 15/20; B60L 2210/14

(57) ABSTRACT

A control method for a DC-DC boost converter of an electrified powertrain includes stoting and accessing a two-dimensional (2D) loss model for the boost converter, the 2D loss model defining (i) a plurality of different sets of quadratic polynomial coefficients for (ii) a plurality of output voltages of the boost converter, respectively, determining, based on a driver torque request, a desired output power and a desired output voltage for the boost converter, determining a particular set of quadratic polynomial coefficients for the desired output voltage for the boost converter to obtain a desired quadratic polynomial function representing a loss of the boost converter to generate the desired output power at the desired output voltage, estimating, using the desired quadratic polynomial function the loss of the boost converter to achieve the driver torque request, and controlling the electrified powertrain based on the estimated loss of the boost converter.

### FIELD

The present application generally relates to electrified vehicles and, more particularly, to loss approximation techniques for electrified vehicle DC-DC boost converters through quadratic fitting.

### BACKGROUND

An electrified vehicle includes at least one electric traction motor powered by a high voltage battery pack or system. In some applications, the electrified vehicle can further include a DC-DC boost converter that enables the boosting of the battery system voltage such that electric motor(s) can operate at higher voltages. These DC-DC boost converters typically include insulated gate bipolar junction (IGBT) transistors or metal-oxide-silicon field-effect (MOSFET) transistors, diodes, capacitors, and inductors. Because of the continuous and varied operating modes of the DC-DC boost converter, the losses of the DC-DC boost converter do not remain constant. While existing literature discusses various methods of estimating losses of individual DC-DC boost converter components to increase its efficiency, there are not currently any techniques for real-time estimation of the overall DC-DC boost converter losses in an electrified vehicle. Accordingly, while such conventional electrified vehicle control systems do work for their intended purpose, there exists an opportunity for improvement in the relevant art.

### SUMMARY

According to one example aspect of the invention, a DC-DC boost converter control system for a DC-DC boost converter of an electrified powertrain of an electrified vehicle is presented. In one exemplary implementation, the DC-DC boost converter control system comprises a memory configured to store a two-dimensional (2D) loss model for the DC-DC boost converter, the 2D loss model defining (i) a plurality of different sets of quadratic polynomial coefficients for (ii) a plurality of output voltages of the DC-DC boost converter, respectively, and a control system configured to access the 2D loss model for the DC-DC boost converter from the memory and to determine, based on a driver torque request, a desired output power and a desired output voltage for the DC-DC boost converter, determine a particular set of quadratic polynomial coefficients for the desired output voltage for the DC-DC boost converter to obtain a desired quadratic polynomial function representing a loss of the DC-DC boost converter to generate the desired output power at the desired output voltage, estimate, using the desired quadratic polynomial function, the loss of the DC-DC boost converter to achieve the driver torque request, and control the electrified powertrain based on the estimated loss of the DC-DC boost converter.

In some implementations, the 2D loss model for the DC-DC boost converter is obtained by reducing a three-dimensional (3D) loss model for the DC-DC boost converter, wherein the 3D loss model defines various losses of the DC-DC boost converter versus (i) the output power of the DC-DC boost converter and (ii) the output voltage of the DC-DC boost converter. In some implementations, a calibration system external to the electrified vehicle is configured to generate the 3D loss model for the DC-DC boost converter and to reduce the 3D loss model for the DC-DC boost converter to the 2D loss model for the DC-DC boost converter.

In some implementations, the calibration system is configured to reduce the 3D loss model for the DC-DC boost converter to the 2D loss model for the DC-DC boost converter by identifying the plurality of output voltage of the DC-DC boost converter as output voltages intended to be used by the electrified vehicle. In some implementations, the calibration system is further configured to generate a look-up table or surface for the 2D loss model for the DC-DC boost converter, wherein the look-up table or surface is configured for determining each set of quadratic polynomial coefficients from each of the plurality of output voltages of the DC-DC boost converter, respectively.

In some implementations, the plurality of output voltages of the DC-DC boost converter comprises 32 different output voltages of the DC-DC boost converter. In some implementations, the calibration system is further configured to transform the 2D loss model for the DC-DC boost converter based on an electrical system configuration of the electrified vehicle. In some implementations, the control system is configured to estimate the loss of the DC-DC boost converter in real-time and online at the control system. In some implementations, the electrified vehicle comprises two electric traction motors configured to be powered, via respective inverters, by the DC-DC boost converter.

According to another aspect of the invention, a DC-DC boost converter control method for a DC-DC boost converter of an electrified powertrain of an electrified vehicle is presented. IN one exemplary implementation, the DC-DC boost converter control method comprises storing, by a memory of the electrified vehicle, a two-dimensional (2D) loss model for the DC-DC boost converter, the 2D loss model defining (i) a plurality of different sets of quadratic polynomial coefficients for (ii) a plurality of output voltages of the DC-DC boost converter, respectively, accessing, by a control system of the electrified vehicle and from a memory, the 2D loss model for the DC-DC boost converter, determining, by the control system and based on a driver torque request, a desired output power and a desired output voltage for the DC-DC boost converter, determining, by the control system, a particular set of quadratic polynomial coefficients for the desired output voltage for the DC-DC boost converter to obtain a desired quadratic polynomial function representing a loss of the DC-DC boost converter to generate the desired output power at the desired output voltage, estimating, by the control system and using the desired quadratic polynomial function, the loss of the DC-DC boost converter to achieve the driver torque request, and controlling, by the control system, the electrified powertrain based on the estimated loss of the DC-DC boost converter.

In some implementations, the 2D loss model for the DC-DC boost converter is obtained by reducing a three-dimensional (3D) loss model for the DC-DC boost converter, wherein the 3D loss model defines various losses of the DC-DC boost converter versus (i) the output power of the DC-DC boost converter and (ii) the output voltage of the DC-DC boost converter. In some implementations, the DC-DC boost converter control method further comprises generating, by a calibration system external to the electrified vehicle, the 3D loss model for the DC-DC boost converter and reducing, by the calibration system, the 3D loss model for the DC-DC boost converter to the 2D loss model for the DC-DC boost converter.

In some implementations, the reducing of the 3D loss model for the DC-DC boost converter to the 2D loss model for the DC-DC boost converter comprises identifying, by the calibration system, the plurality of output voltage of the DC-DC boost converter as output voltages intended to be used by the electrified vehicle. In some implementations, the DC-DC boost converter control method further comprises generating, by the calibration system, a look-up table or surface for the 2D loss model for the DC-DC boost converter, wherein the look-up table or surface is configured for determining each set of quadratic polynomial coefficients from each of the plurality of output voltages of the DC-DC boost converter, respectively. In some implementations, the plurality of output voltages of the DC-DC boost converter comprises 32 different output voltages of the DC-DC boost converter.

In some implementations, the DC-DC boost converter control method further comprises transforming, by the calibration system the 2D loss model for the DC-DC boost converter based on an electrical system configuration of the electrified vehicle. In some implementations, the estimating of the loss of the DC-DC boost converter is performed in real-time and online at the control system. In some implementations, the electrified vehicle comprises two electric traction motors configured to be powered, via respective inverters, by the DC-DC boost converter.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of an electrified vehicle having an electrical system with a DC-DC boost converter and having an example DC-DC boost control system according to the principles of the present application;

FIG. 2 is a circuit diagram of an example configuration of the electrical system with the DC-DC boost converter of the electrified vehicle of FIG. 1 according to the principles of the present application;

FIG. 3 is a flow diagram of an example DC-DC boost control method for an electrified vehicle having an electrical system with a DC-DC boost converter according to the principles of the present application; and

FIGS. 4A-4C are plots of an example quadratic fitting process for estimating losses of an electrified vehicle DC-DC boost converter according to the principles of the present application.

### DESCRIPTION

As previously discussed, an electrified vehicle includes at least one electric traction motor powered by a high voltage battery pack or system. Some electrified vehicles have DC-DC boost converters that enable the boosting of the battery system's voltage such that electric motor(s) can operate at higher voltages. These DC-DC boost converters typically include insulated gate bipolar junction (IGBT) transistors or metal-oxide-silicon field-effect (MOSFET) transistors, diodes, capacitors, and inductors. Because of the continuous and varied operating modes of the DC-DC boost converter, the losses of the DC-DC boost converter does not remain constant. The existing literature only discusses various methods of estimating losses of individual DC-DC boost converter components to increase its efficiency.

For example, complex loss estimation techniques employing machine-learning, such as multi-layer perceptron (MLP), support vector machines (SVM), K-nearest neighbors (KNN), and random forest (RF), have been proved to be effective and highly accurate with quick convergence speeds. These conventional methods of computing the losses, however, are not deemed practical to implement within the purview of a real-time embedded vehicle controller. More specifically, these conventional methods could result in higher throughput of the real-time code, thereby resulting in longer turn-around times and task dropouts. Additionally, all of these conventional methods are utilized for estimating the losses of individual DC-DC boost converter elements to thereafter improve the overall efficiency of the DC-DC boost converter (e.g., via design or control changes).

Accordingly, real-time loss estimation techniques for electrified vehicle DC-DC boost converters are desired and are presented herein. The DC-DC boost converter's losses are be modeled by a quadratic function where the independent variable is output power and the coefficients are determined through a parameter estimation technique and collected empirical operation data. This process is repeated with a three-dimensional (3D) quadratic function such that the independent variables are output power and DC-DC boost converter voltage. This 3D quadratic function or loss model can then be reduced to a two-dimensional (2D) loss model by assuming an output voltage with coefficients based thereon (e.g., using a look-up table). Potential benefits of these techniques include accurate real-time estimation of DC-DC boost converter losses in electrified vehicles without extra hardware requirements (e.g., for 3D surface processing).

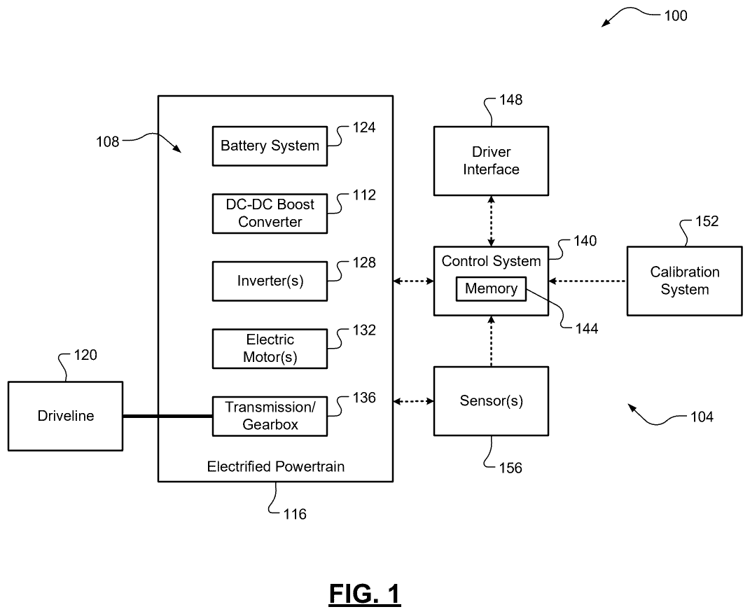

Referring now to FIG. 1, a functional block diagram of an electrified vehicle 100 having an electrical system 108 comprising a DC-DC boost converter 112 and having an example DC-DC boost control system 104 according to the principles of the present application is illustrated. As shown, the electrified vehicle 100 generally comprises an electrified powertrain 116 configured to generate and transfer drive torque to a driveline 120 for vehicle propulsion. The electrified powertrain 116 includes a high voltage battery pack or system 124, the DC-DC boost converter 112, and one or more inverters 128 and electric traction motors 132. In one exemplary embodiment, the electrified powertrain 116 includes two inverters 128 and two respective electric traction motors 132. In another embodiment, the electrified powertrain 116 could include up to three inverters 128 and three respective electric traction motors 132.

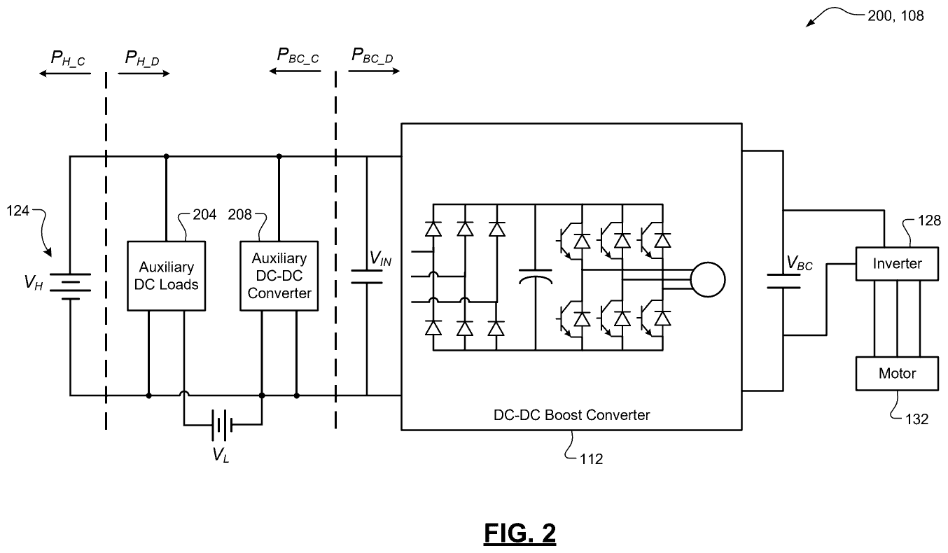

In some embodiments, the electrified powertrain 116 could further comprise an internal combustion engine (not shown) configured for high voltage support and/or propulsion assistance. Drive torque generated by the electric motor(s) 132 (and optionally, the engine) is transferred to the driveline 120 via an optional transmission or gearbox 136. The electrical system 108 includes, among other non-illustrated components (some of which are also shown in FIG. 2), the battery system 124, the DC-DC boost converter 112, the inverter(s) 128, and the electric motor(s) 132. A controller or control system 140, which could comprise one or more electronic control units (ECUs) connected via a controller area network (CAN), is configured to control the electrified vehicle 100 and, more particularly, the electrified powertrain 116, to generate a sufficient amount of drive torque to satisfy a driver torque request (e.g., provided by a driver via a driver interface 148, such as an accelerator pedal).

The control system 140 includes an internal or other memory 144 associated therewith that is configured to store data, such as empirical operation data for the DC-DC boost converter 112 as discussed in greater detail below. This empirical operation data could be generated, for example, during an offline data collection or calibration procedure and subsequently uploaded and stored at the memory 144. Some of the aspects of the present application as discussed in greater detail below could also be performed offline and subsequently uploaded and stored at the memory 144 for subsequent usage and improved control of the DC-DC boost converter 112. Thus, it will be appreciated that there could be an external calibration system 152 that is configured to generate and upload this data to the memory 144. A plurality of sensors 156 can be configured to measure various operating parameters of the electrified vehicle 100, such as, but not limited to, positions/speeds/accelerations, temperatures, pressures, and electrical parameters (current, voltage, etc.).

Referring now to FIG. 2 and with continued reference to FIG. 1, a circuit diagram of an example configuration 200 of the electrical system 108 of the electrified vehicle 100 of FIG. 1 including the DC-DC boost converter 112 according to the principles of the present application is illustrated. The electrical system 108 generally comprises the high voltage battery system 124 (V_{H}), a low voltage battery system (V_{L}), and auxiliary DC loads 204 and an auxiliary DC-DC converter (for supporting the low voltage battery/loads). The components of the DC-DC boost converter 112 generally consist of one or more semiconductor devices—usually, insulated gate bipolar transistors (IGBT) or metal-oxide-semiconductor field-effect transistors (MOSFET)—diodes, capacitors, and inductors. One example electrical configuration of the DC-DC boost converter 112 is generally illustrated in FIG. 2. The losses that arise within the DC-DC boost converter 112 are primarily due to the conduction and switching elements of the power electronics, along with parasitic losses due to operations of the gate drivers, signaling circuits, and the semiconductors themselves.

Consequently, because of the continuous and varied operating modes of the circuits and variations in the electrical load during the voltage transformation, the losses of the switching elements do not remain constant. In other words, the switching frequency, duty cycle, and the undulating load heavily influence the efficiency of the DC-DC boost converter 112. However, the intention of the present invention is not to measure or evaluate the individual losses in the DC-DC boost converter 112 and neither to improve its operational efficiency, but to instead mathematically estimate the overall losses based on current operating conditions of the electrified powertrain 116 and appropriately account for them within the electrified vehicle's torque control system. Within some torque control systems, the system power limits, and the optimal commanded engine and electric motor power are used in multiple locations. In one electrified powertrain, these power limits and actual power are purely derived from the high voltage battery system 124, but in this case along with the battery system 124, the DC-DC boost converter 112 plays a critical role.

As shown, the power domain of the torque control system is on the high voltage battery side since previous configurations may not have utilized a DC-DC boost converter 112. In FIG. 2, P_{H_C} and P_{H_D} represent the battery charge and discharge limits, respectively, and P_{BC_C} and P_{BC_D} represent the DC-DC boost converter charge and discharge limits, respectively. To maintain the same structure of existing software, the estimated losses on the DC-DC boost converter side may need to be converted to the battery side before they can be used for any calculations. The usage of power limits and actual power can be, but is not limited to, (1) determining the achievable torque limits of the driver torque request, (2) determining the achievable torque limits of the electric motor(s) 132 (and optionally, the engine), and (3) optionally, determining the achievable speed limit of the engine. The introduction of the DC-DC boost converter 112 makes these calculations exponentially complicated.

There are multiple stages of power limitations within the system, i.e., battery power limits and DC-DC boost converter power limits. Either one of those two power limits can be the limiting factor, and the winning arbitrator can vary depending on the vehicle conditions. Therefore, it is essential to consider the losses of the DC-DC boost converter 112 so that the accurate power limits are used within the torque control system. The estimation of the DC-DC boost converter loss is a challenge due to (1) multiple situations considered in the system i.e., the current electric power usage and the future electric power usage, which happens during optimization, and (2) at different power limits and usages, the power losses are different, which creates a mathematical loop in the calculation, since the power loss is also effecting the power limits, and then the power usage itself. The present application therefore describes a systematic method for estimating the losses of the DC-DC boost converter 112, which will now be described in even greater detail.

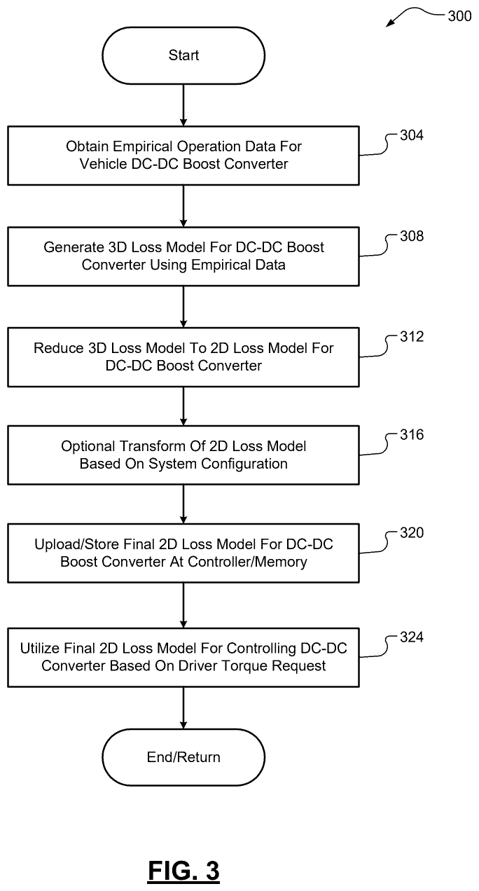

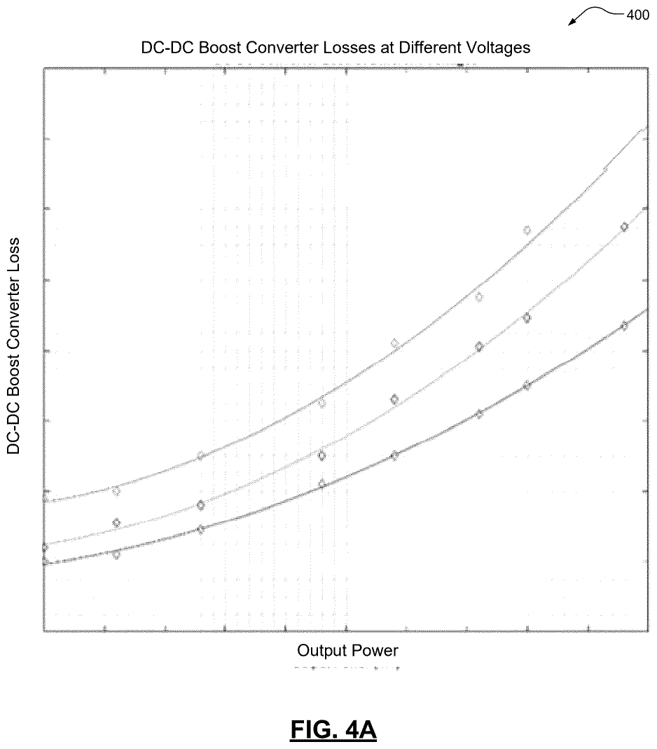

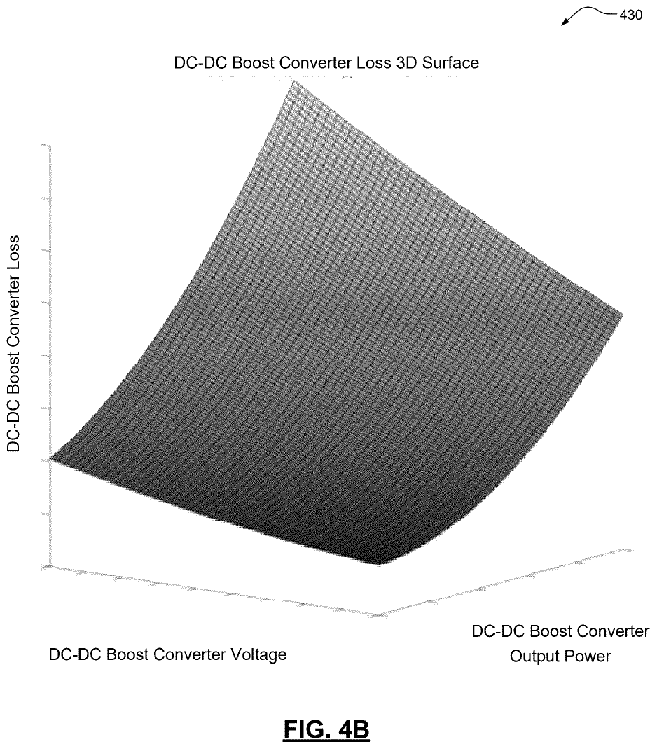

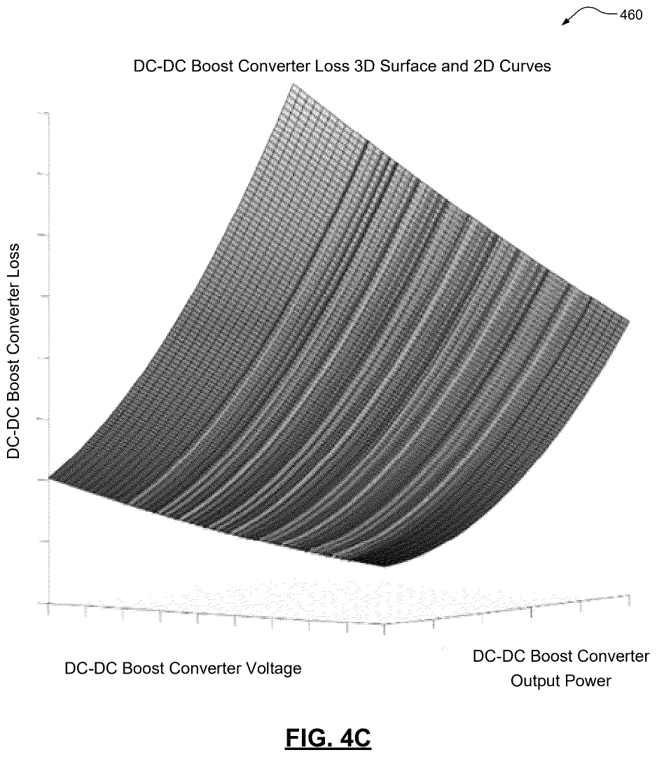

Referring now to FIGS. 3 and 4A-4C and with continued reference to the previous figures, a flow diagram of an example DC-DC boost control method 300 for an electrified vehicle having a DC-DC boost converter and example plots 400, 430, and 460 of an example quadratic fitting process according to the principles of the present application are illustrated.

To characterize the losses of the DC-DC boost converter 112, empirical data can first be collected at all intended voltages of operation along with a variety of converter output powers in step 304. It was found that the losses of the DC-DC boost converter 112 can best be modeled by a quadradic fitting function where the independent variable is output power (P₀) as described in Equation (1) below where coefficients a₁, a₂, and a₃ are determined through an appropriate parameter estimation technique.

$${P}_{C o n v L o s s} ( {P}_{o} ) = {a}_{1} * {P}_{o}^{2} + {a}_{2} * {P}_{o} + {a}_{3} . \qquad ( 1 )$$

This approach can be followed for all intended voltages of operation of the DC-DC boost converter 112 (i.e., output voltage V_{BC}). FIG. 4A in particular illustrates a plot 400 showing example DC-DC boost converter losses at three different operating voltages V_{BC} (e.g., in volts, or V) and quadratic function approximation as a function of output power P₀ (e.g., in kilowatts, or kW). The small diamond-shape points illustrate example empirical operation datapoints and the curves represent three different quadratic representations derived from the respective empirical operation datapoints.

To better represent the DC-DC boost converter's loss across the full range of intended operating voltages V_{BC}, the above-described loss approximation approach can be repeated with a 3D quadratic function at step 308 where the independent variables are output power P₀, and DC-DC boost converter voltage V_{BC} as described in Equation (2) below:

$${P}_{C o n v L o s s} ( {P}_{o} , {V}_{B C} ) = {p}_{1} * {P}_{o}^{2} + {p}_{2} * {V}_{B C}^{2} + {p}_{3} * {P}_{o} * {V}_{B C} + {p}_{4} * {P}_{o} + {p}_{5} * {V}_{B C} + {p}_{6} , \qquad ( 2 )$$

where p₁, p₂, p₃, p₄, p₅, and p₆ are determined through an appropriate parameter estimation technique. The resulting 3D DC-DC boost converter loss model, an example of which is shown in the plot 430 of FIG. 4B, can then be reduced to a 2D DC-DC boost converter loss model at step 312 by assuming an output voltage V_{BC,s} as shown below in Equation (3).

$${P}_{C o n v L o s s} ( {P}_{o} ) = {λ}_{1} * {P}_{o}^{2} + {λ}_{2} * {P}_{o} + {λ}_{3} \qquad ( 3 )$$

$$where {λ}_{1} = {p}_{1} , {λ}_{2} = ( {p}_{3} * {V}_{B C , S} + {p}_{4} ) , and$$

$${λ}_{3} = ( {p}_{2} * {V}_{BC , S}^{2} + {p}_{5} * {V}_{B C , S} + {p}_{6} ) .$$

For convenience, P_{ConvLoss}(P₀) can be re-written as shown below in Equation (4).

$${P}_{C o n v L o s s} ( {P}_{o} ) = {( {k}_{1} * {P}_{o} + {k}_{2} )}^{2} + {k}_{3} \qquad ( 4 )$$

$$where {k}_{1} = \sqrt{{λ}_{1}} , {k}_{2} = {λ}_{2} / [ 2 * \sqrt{{λ}_{1}} ] , and {k}_{3} = {λ}_{3} - {( {λ}_{2} / [ 2 * \sqrt{{λ}_{1}} ] )}^{2} .$$

The above-described 3D DC-DC boost converter loss model would need to implemented in an embedded processor and computational resources would therefore be an issue to be considered. In the reduced 2D DC-DC boost converter loss model, however, coefficients k₁, k₂, and k₃ can be looked up as a function of V_{BC,s}. This lookup functionality can be implemented using a binary search (e.g., 32 different values of V_{BC,s}) as shown in plot 460 of FIG. 4C. Finally, depending on the location of the application of the 2D DC-DC boost converter loss model within the torque control software architecture, one must consider the loss from the previously-mentioned “motor side” or the “input side” of the system, which is shown in FIG. 2. The DC-DC boost converter loss can be transformed from the “motor side” P₀ to the “input side” Pᵢ of the system by applying the following transformation shown in Equations (5), (6), and (7) below:

$${P}_{C o n v L o s s} = {( {k}_{1} * {P}_{o} + {k}_{2} )}^{2} + {k}_{3} = {k}_{1}^{2} * {P}_{o}^{2} + 2 * {k}_{1} * {k}_{2} * {P}_{o} + {k}_{3} + {k}_{2}^{2} \qquad ( 5 )$$

$${P}_{i} = {P}_{o} + {P}_{C o n v L o s s} = {P}_{o} + {k}_{1}^{2} * {P}_{o}^{2} + 2 * {k}_{1} * {k}_{2} * {P}_{o} + {k}_{3} + {k}_{2}^{2} , and \qquad ( 6 )$$

$${P}_{i} = {k}_{1}^{2} * {P}_{o}^{2} + ( 1 + 2 * {k}_{1} * {k}_{2} ) * {P}_{o} + {k}_{3} + {k}_{2}^{2} = {γ}_{1} * {P}_{o}^{2} + {γ}_{2} * {P}_{o} + {γ}_{3} . \qquad ( 7 )$$

Rearranging Equation (7) as follows will give P₀=f(Pᵢ).

$${P}_{o} = - ( [ {γ}_{2} \pm \sqrt{{γ}_{2}^{2} - 4 * {γ}_{1} * {γ}_{2} + 4 * {γ}_{1} * {P}_{i}} ] / [ 2 * {γ}_{1} ] ) . \qquad ( 8 )$$

Substituting the above expression for P₀=f(Pᵢ) into Equation (8) above results in DC-DC boost converter loss on the “input side”.

$${P}_{i} = {P}_{o} + {P}_{C o n v L o s s} ⇒ {P}_{C o n v L o s s} = {P}_{i} - {P}_{o} = {P}_{i} + \frac{{γ}_{2} \pm \sqrt{{γ}_{2}^{2} - 4 * {γ}_{1} * {γ}_{2} + 4 * {γ}_{1} * {P}_{i}}}{2 * {γ}_{1}} \qquad ( 9 )$$

The above-described transformation could be performed at optional step 320. At step 324, the final (2D) DC-DC boost converter loss model is uploaded to the memory 144 of the control system 140 and stored. Finally, at step 328, the control system 140 utilizes the final DC-DC boost converter loss model for improved loss estimation of the DC-DC boost converter 140 and improved torque control of the electrified powertrain 116. The method 300 then ends or returns to 324 for continued usage during operation of the electrified vehicle 100.

To briefly summarize, the uniqueness of this newly proposed solution is due to the structure of the torque control system established for existing electrified powertrain architectures, wherein the estimated losses on the DC-DC boost converter side need to be mathematically transformed into the high voltage battery domain. This newly proposed solution estimates the overall losses and not the individual losses in the converter using the methodology of curve fitting with the inverter voltage and the current output power as the independent variables, which approximates the losses across the operating range of the powertrain with minimal errors in the calculations. This newly proposed solution is also a simple solution that can be implemented in a real-time electrified vehicle controller without adding additional throughput (e.g., improved, more expensive hardware).

It will be appreciated that the terms “controller” and “control system” as used herein refer to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

1. A DC-DC boost converter control system for a DC-DC boost converter of an electrified powertrain of an electrified vehicle, the DC-DC boost converter control system comprising:
a memory configured to store a two-dimensional (2D) loss model for the DC-DC boost converter, the 2D loss model defining (i) a plurality of different sets of quadratic polynomial coefficients for (ii) a plurality of output voltages of the DC-DC boost converter, respectively; and
a control system configured to access the 2D loss model for the DC-DC boost converter from the memory and to:
determine, based on a driver torque request, a desired output power and a desired output voltage for the DC-DC boost converter;
determine a particular set of quadratic polynomial coefficients for the desired output voltage for the DC-DC boost converter to obtain a desired quadratic polynomial function representing a loss of the DC-DC boost converter to generate the desired output power at the desired output voltage;
estimate, using the desired quadratic polynomial function, the loss of the DC-DC boost converter to achieve the driver torque request; and
control the electrified powertrain based on the estimated loss of the DC-DC boost converter.

2. The DC-DC boost converter control system of claim 1, wherein the 2D loss model for the DC-DC boost converter is obtained by reducing a three-dimensional (3D) loss model for the DC-DC boost converter, wherein the 3D loss model defines various losses of the DC-DC boost converter versus (i) the output power of the DC-DC boost converter and (ii) the output voltage of the DC-DC boost converter.

3. The DC-DC boost converter control system of claim 2, wherein a calibration system external to the electrified vehicle is configured to generate the 3D loss model for the DC-DC boost converter and to reduce the 3D loss model for the DC-DC boost converter to the 2D loss model for the DC-DC boost converter.

4. The DC-DC boost converter control system of claim 3, wherein the calibration system is configured to reduce the 3D loss model for the DC-DC boost converter to the 2D loss model for the DC-DC boost converter by identifying the plurality of output voltage of the DC-DC boost converter as output voltages intended to be used by the electrified vehicle.

5. The DC-DC boost converter control system of claim 4, wherein the calibration system is further configured to generate a look-up table or surface for the 2D loss model for the DC-DC boost converter, wherein the look-up table or surface is configured for determining each set of quadratic polynomial coefficients from each of the plurality of output voltages of the DC-DC boost converter, respectively.

6. The DC-DC boost converter control system of claim 5, wherein the plurality of output voltages of the DC-DC boost converter comprises 32 different output voltages of the DC-DC boost converter.

7. The DC-DC boost converter control system of claim 3, wherein the calibration system is further configured to transform the 2D loss model for the DC-DC boost converter based on an electrical system configuration of the electrified vehicle.

8. The DC-DC boost converter control system of claim 1, wherein the control system is configured to estimate the loss of the DC-DC boost converter in real-time and online at the control system.

9. The DC-DC boost converter control system of claim 1, wherein the electrified vehicle comprises two electric traction motors configured to be powered, via respective inverters, by the DC-DC boost converter.

10. A DC-DC boost converter control method for a DC-DC boost converter of an electrified powertrain of an electrified vehicle, the DC-DC boost converter control method comprising:
storing, by a memory of the electrified vehicle, a two-dimensional (2D) loss model for the DC-DC boost converter, the 2D loss model defining (i) a plurality of different sets of quadratic polynomial coefficients for (ii) a plurality of output voltages of the DC-DC boost converter, respectively;
accessing, by a control system of the electrified vehicle and from a memory, the 2D loss model for the DC-DC boost converter;
determining, by the control system and based on a driver torque request, a desired output power and a desired output voltage for the DC-DC boost converter;
determining, by the control system, a particular set of quadratic polynomial coefficients for the desired output voltage for the DC-DC boost converter to obtain a desired quadratic polynomial function representing a loss of the DC-DC boost converter to generate the desired output power at the desired output voltage;
estimating, by the control system and using the desired quadratic polynomial function, the loss of the DC-DC boost converter to achieve the driver torque request; and
controlling, by the control system, the electrified powertrain based on the estimated loss of the DC-DC boost converter.

11. The DC-DC boost converter control method of claim 10, wherein the 2D loss model for the DC-DC boost converter is obtained by reducing a three-dimensional (3D) loss model for the DC-DC boost converter, wherein the 3D loss model defines various losses of the DC-DC boost converter versus (i) the output power of the DC-DC boost converter and (ii) the output voltage of the DC-DC boost converter.

12. The DC-DC boost converter control method of claim 11, further comprising generating, by a calibration system external to the electrified vehicle, the 3D loss model for the DC-DC boost converter and reducing, by the calibration system, the 3D loss model for the DC-DC boost converter to the 2D loss model for the DC-DC boost converter.

13. The DC-DC boost converter control method of claim 12, wherein the reducing of the 3D loss model for the DC-DC boost converter to the 2D loss model for the DC-DC boost converter comprises identifying, by the calibration system, the plurality of output voltage of the DC-DC boost converter as output voltages intended to be used by the electrified vehicle.

14. The DC-DC boost converter control method of claim 13, further comprising generating, by the calibration system, a look-up table or surface for the 2D loss model for the DC-DC boost converter, wherein the look-up table or surface is configured for determining each set of quadratic polynomial coefficients from each of the plurality of output voltages of the DC-DC boost converter, respectively.

15. The DC-DC boost converter control method of claim 14, wherein the plurality of output voltages of the DC-DC boost converter comprises 32 different output voltages of the DC-DC boost converter.

16. The DC-DC boost converter control method of claim 12, further comprising transforming, by the calibration system the 2D loss model for the DC-DC boost converter based on an electrical system configuration of the electrified vehicle.

17. The DC-DC boost converter control method of claim 10, wherein the estimating of the loss of the DC-DC boost converter is performed in real-time and online at the control system.

18. The DC-DC boost converter control method of claim 10, wherein the electrified vehicle comprises two electric traction motors configured to be powered, via respective inverters, by the DC-DC boost converter.
